(19) United States
(12) Patent Application Publication
(10) Pub. No.: US 2013/0178112 A1
(43) Pub. Date: Jul. 11, 2013

(54) Connection Interface and Cable

(71) Applicants: Shu-Te Su, New Taipei City (TW); Yung-Chi Sung, New Taipei City (TW); Wei-Ming Chien, New Taipei City (TW)

(72) Inventors: Shu-Te Su, New Taipei City (TW); Yung-Chi Sung, New Taipei City (TW); Wei-Ming Chien, New Taipei City (TW)

(21) Appl. No.: 13/455,098

(22) Filed: Apr. 24, 2012

(30) Foreign Application Priority Data
Jan. 5, 2012 (TW) 101100453

(51) Int. Cl. H01R 24/00

(52) U.S. Cl. 439/660

(57) ABSTRACT

The invention discloses a connection interface. The connection interface includes a first set of pins, including a plurality of pins corresponding to Universal Serial Bus (USB) 3.0 specifications; and a second set of pins, including a plurality of pins corresponding to USB 2.0 specifications; wherein the first set of pins and the second set of pins are arranged side-by-side with each other, and the second set of pins are arranged according to a front panel header definition of the USB 2.0 specifications.

### BACKGROUND OF THE INVENTION

1. Field of the Invention

The present invention relates to a connection interface of Universal Serial Bus 3.0 (USB 3.0), and more particularly, to a connection interface with a front panel header definition capable of reducing required types of cable and manufacturing cost.

2. Description of the Prior Art

Universal Serial Bus (USB) is a connection specification established by some of leaders of the industry, and has characteristics such as easy-to-use, good extensibility and high speed. The operation speed of the USB 3.0 issued at 2008 reaches 5 Gbit/s, and is ten times faster than the operation speed of USB 2.0 (480 Mbps). So far, the USB has extensively applied in various electronic products.

At the end of 2010, two main central processing unit (CPU) manufacturers Intel and AMD announce chip sets of the next generation will support the USB 3.0 interface, but the chip sets of Intel and those of AMD will have different front panel header definitions of the USB 3.0 specifications. Since a computer needs a specific cable to connect a circuit board and a USB port assembled on a housing of the computer, two different motherboards designed respectively according to the front panel header definitions of the chip set of Intel and the chip set of AMD need different USB 3.0 cables due to the different front panel header definitions. As a result, types of the cable and possibility of erroneously assembling increase. The material cost and the manufacturing cost also rise.

Furthermore, Intel and AMD both produce chip sets supporting and not supporting the USB 3.0 (i.e. Intel chip sets H77, H61 and AMD chip sets A75, A55). If a chip set supporting the USB 3.0 is assembled on a motherboard and needs to be replaced by a chip set not supporting the USB 3.0, a new specification of USB 2.0 cable is required due to inconsistency between the front panel header definition of the USB 2.0 specifications and that of current specifications.

In detail, please refer to FIG. 1A, which is a schematic diagram a conventional connection interface 100 conforming to the front panel header definition of the USB 2.0 specifications. As shown in FIG. 1A, the connection interface only comprises 10 pins, which comprises a first differential pair of pins USB2_D1+, USB2_D1− (pins 6, 8), a second differential pair of pins USB2_D2+, USB2_D2− (pins 5, 7), power pins USB_VBUS (pins 9, 10) and ground pins GND (pins 3, 4). The power pins USB_VBUS and the ground pins GND are respectively corresponding to each differential pair of pins. Finally, a pin 1 and a pin 2 are respectively a ground pin GND and a not connected (NC) pin, and are utilized for dummy-proof procedure of the motherboard to prevent the connector from being erroneously connected.

Next, please refer to FIG. 1B and FIG. 1C, which are schematic diagrams of connection interfaces 102 and 104 according to the front panel header definitions established by Intel and AMD, respectively. As shown in FIG. 1B and FIG. 1C, the connection interfaces 102 and 104 established by Intel and AMD both comprise 20 pins, wherein the pins for the USB 3.0 comprises a first receiving differential pair of pins USB3_SSRX1+, USB3_SSRX1−, a first transmitting differential pair of pins USB3_SSTX1+, USB3_SSTX1−, a second receiving differential pair of pins USB3_SSRX2+, USB3_SSRX2−, and a second transmitting differential pair of pins USB3_SSTX2+, USB3_SSTX2−. Furthermore, since both of the connection interfaces 102 and 104 are backward compatible to the USB 2.0, pins of the connection interfaces 102 and 104 both further comprise each pin of the first differential pair of pins USB2_D1+, USB2_D1− and the second differential pair of pins USB2_D2+, USB2_D2− of the connection interface 100 shown in FIG. 1A. However, differences between the connection interfaces 102 and 104 are that the corresponding pins of the connection interfaces 102 and 104 are at different relative positions. For example, the first receiving differential pair of pins USB3_SSRX1+, USB3_SSRX1− for the USB 3.0 are respectively at pins 2, 3 of the connection interface 102 (FIG. 1B) but are respectively at pins 17, 18 of the connection interface 104 (FIG. 1C). In addition, the first differential pair of pins for the USB 2.0 USB2_D1+, USB2_D1− are respectively at pins 8, 9 of the connection interface 102, but are at pins 11, 12 of the connection interface 104. Finally, the dummy-proof pins NC of the connection interfaces 102 and 104 are also at opposite positions.

As can be seen from the above, motherboards designed respectively according to the front panel header definitions of Intel and AMD cannot jointly use a cable of a transmission port; thus, the manufacturing cost rises. Besides, if the motherboards co-operate with chip sets or transmission ports of the USB 2.0 specifications, the USB 2.0 cables also cannot be used and a new cable specification (from 20 pins to 10 pins) needs to be established. The required plastic area of the new cable specification is double of those of the existed cable of the USB 2.0 specifications and the number of pins of the new cable specification is also substantially doubled, which increases the material cost and the manufacturing cost rise, and is not environmentally friendly.

Therefore, developing a front panel header definition of the USB 3.0 specifications capable of reducing required types of cable and jointly using the existed USB 2.0 cable to reduce the material cost and the manufacturing cost becomes a common goal in the industry.

### SUMMARY OF THE INVENTION

An embodiment of the invention discloses a connection interface. The connection interface comprises a first set of pins, comprising a plurality of pins corresponding to Universal Serial Bus (USB) 3.0 specifications; and a second set of pins, comprising a plurality of pins corresponding to USB 2.0 specifications; wherein the first set of pins and the second set of pins are arranged side-by-side with each other, and the second set of pins are arranged according to a front panel header definition of the USB 2.0 specifications.

An embodiment of the invention further discloses a cable, for connecting a circuit board and a Universal Serial Bus (USB) transmission port to transmit data between the circuit board and the USB transmission port. The cable comprises a first connector, for connecting to the circuit board, comprising a first set of pins, comprising a plurality of pins corresponding to USB 3.0 specifications; and a second set of pins, comprising a plurality of pins corresponding to USB 2.0 specifications; and a second connector for connecting to the USB port, comprising: a third set of pins, comprising a plurality of pins corresponding to the USB 3.0 specifications, respectively coupled to the first set of pins of the first connector; and a fourth set of pins, comprising a plurality of pins corresponding to the USB 2.0 specifications, respectively coupled to the second set of pins of the first connector; wherein the first set of pins and the second set of pins are arranged side-by-side with each other, the third set of pins and the fourth set of pins are arranged side-by-side with each other, and the second set of pins and the fourth set of pins are arranged according to a front panel header definition of the USB 2.0 specifications.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A-1C are schematic diagrams of front panel header definitions of conventional USB specifications.

FIG. 2 is a schematic diagram of a front panel header definition of USB specifications according to an embodiment of the invention.

FIG. 3 is a schematic diagram of a data transmission system according to an embodiment of the invention.

FIG. 4 is a schematic diagram of a data transmission system according to an embodiment of the invention.

### DETAILED DESCRIPTION

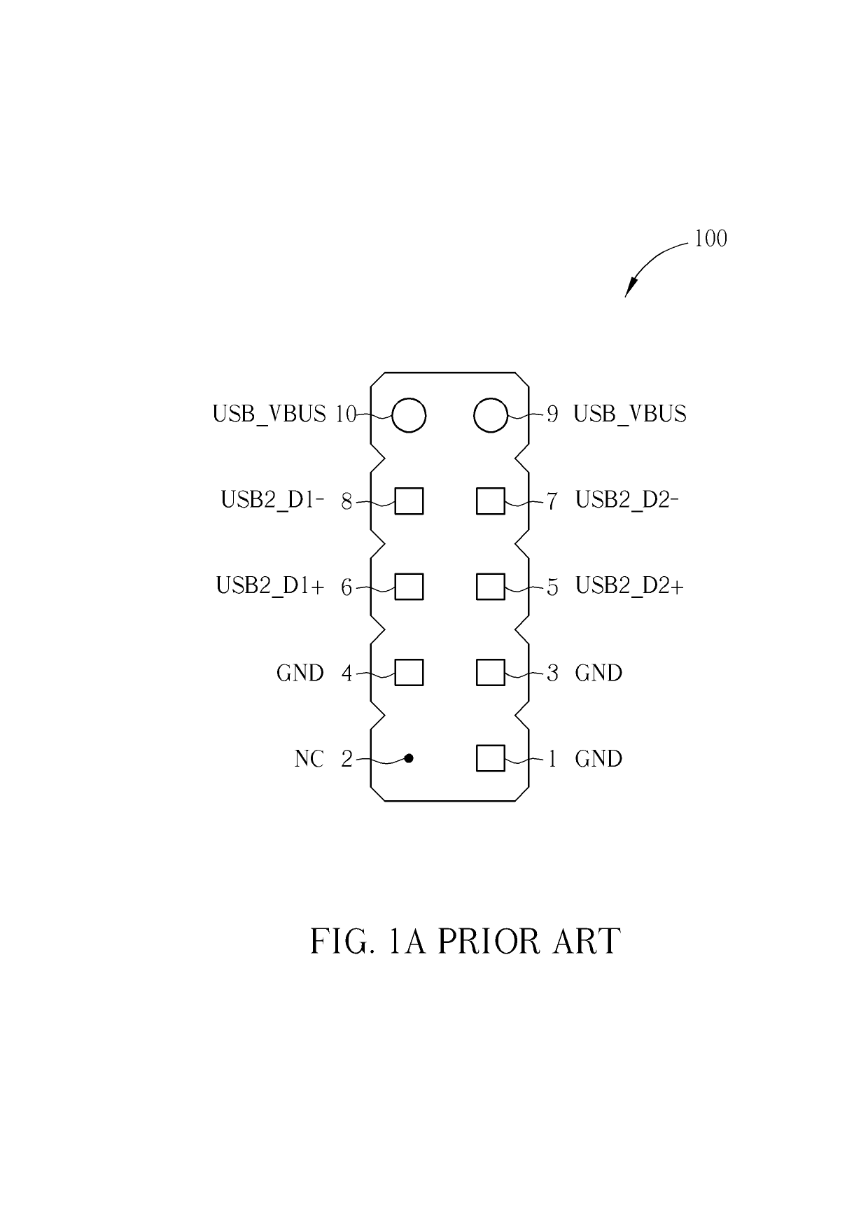

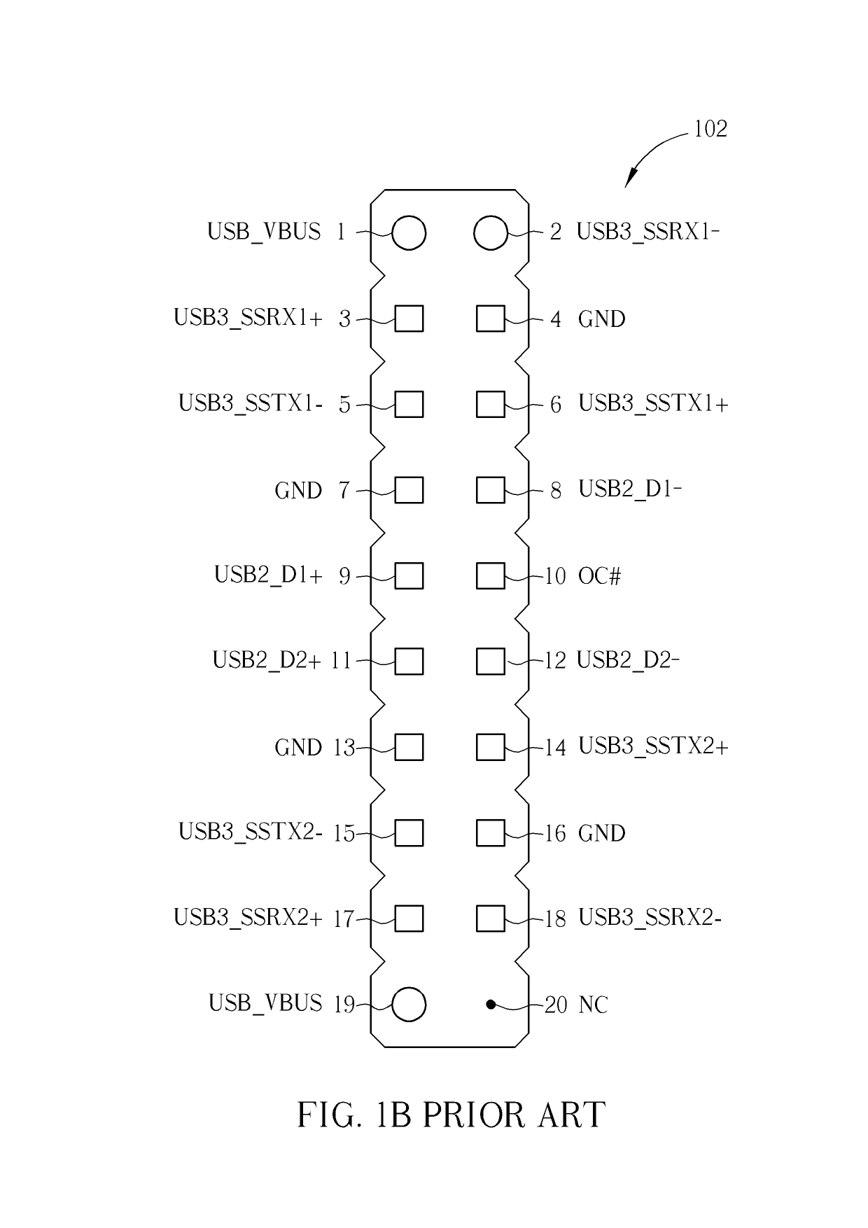

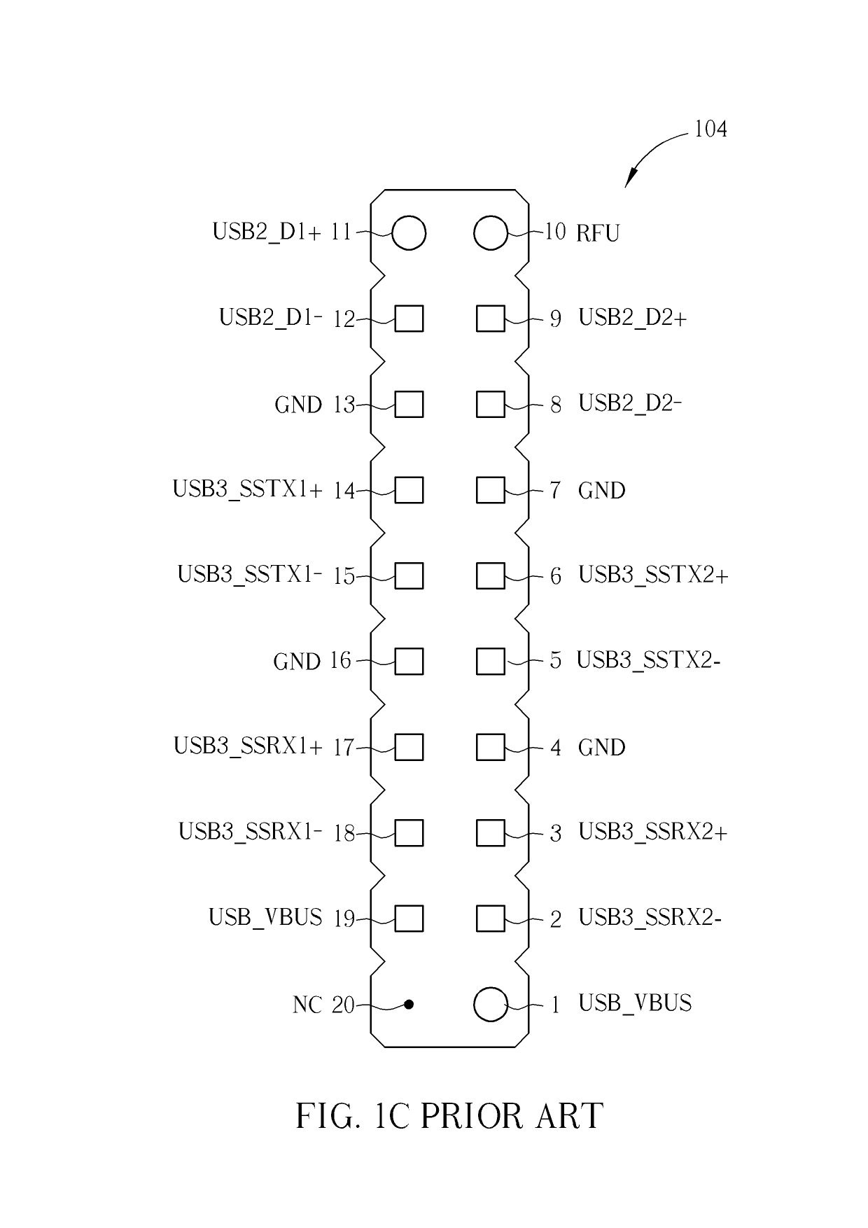

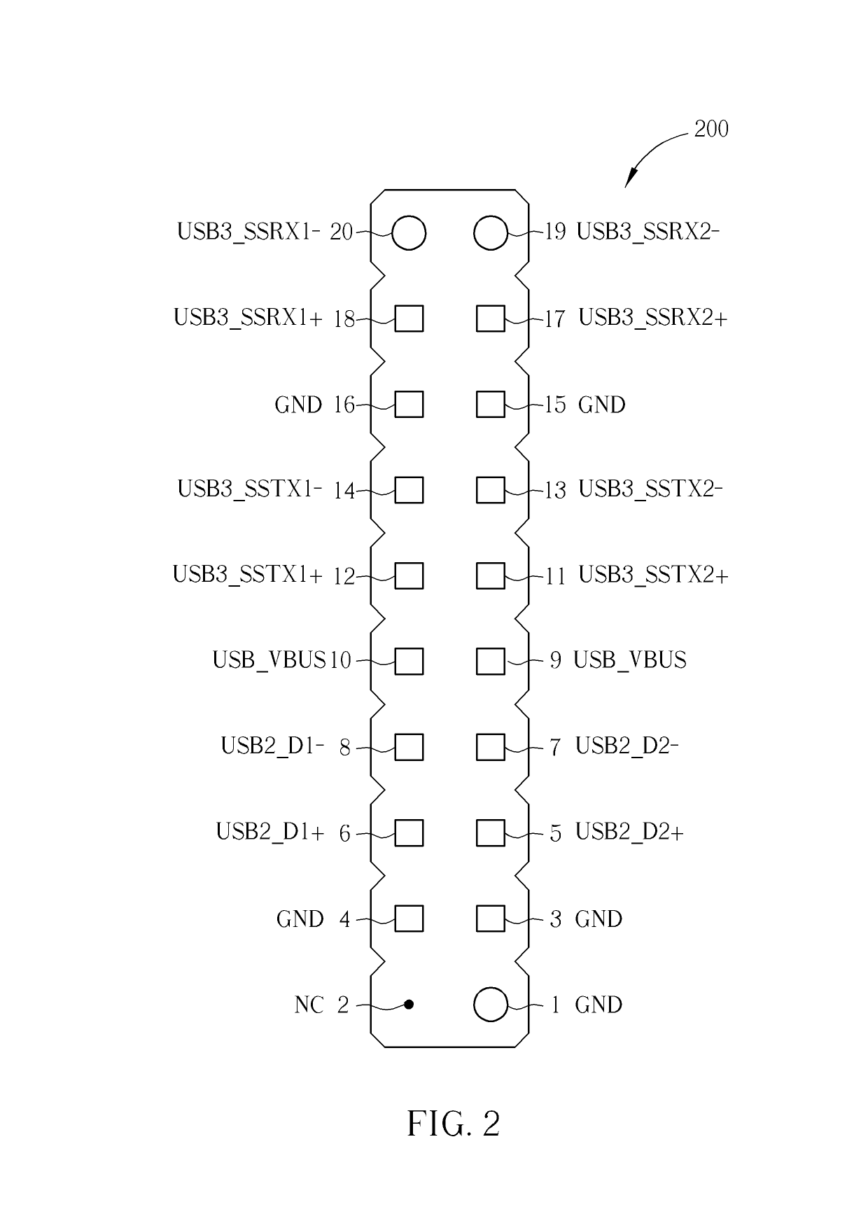

Please refer to FIG. 2, which is a schematic diagram of a connection interface 200 according to an embodiment of the invention. The connection interface 200 can be utilized in data transmissions of the USB 3.0, also can be backward compatible to data transmissions of the USB 2.0. The connection interface 200 comprises pins 1-20. As shown in FIG. 2, each pin of the pins 1-10 and arrangement thereof conform to the front panel header definition of the current USB 2.0 specifications, i.e. the connection interface 100 shown in FIG. 1A. On the other hand, each pin of the pins 11-20 is respectively corresponding to pins for the USB 3.0 specifications of the connection interfaces 102 and 104 shown in FIG. 1B and FIG. 1C.

Simply speaking, different from the connection interfaces 102 and 104 conforming to the USB 3.0 specifications, the pins for backward-supporting the USB 2.0 specifications of the connection interface 200 (pins 1-10) are independent and are arranged side-by-side with the pins corresponding to the USB 3.0 specifications (pins 11-20) in two independent blocks. Therefore, when a motherboard configured with the connection interface 200 co-operates with a chip set or a USB port which does not support USB 3.0 specifications, an existed USB 2.0 cable can be directly utilized for connecting to the lower part of the connection interface 200 (i.e. the pins 1-10) to achieve the USB 2.0 transmission function without re-establishing a USB 2.0 cable of a new specification. Thus, the material cost and the manufacturing cost can be effectively reduced.

In detail, the pins 1-10 of the connection interface 200 are those of the USB 2.0 connection interface 100 shown in FIG. 1A. Therefore, the pins 1-10 can be directly couple to the existed USB 2.0 cable. Next, the pins 11-20 are corresponding to the pins utilized for the USB 3.0 specification of the connection interfaces 102 and 104 shown in FIG. 1B and FIG. 1C. The pins 18, 20 are respectively the first receiving differential pair of pins USB3_SSRX1+, USB3_SSRX1− of the USB 3.0 specifications, and are corresponding to the pins 2, 3 of the connection interface 102 established by Intel (shown in FIG. 1B) or the pins 17, 18 of the connection interface 104 established by AMD (shown in FIG. 1C). The pins 12, 14 are respectively the first transmission differential pair of pins USB3_SSTX1+, USB3_SSTX1− of the USB 3.0 specifications, and are corresponding to the pins 5, 6 of the connection interface 102 or the pins 14, 15 of the connection interface 104. The pins 17, 19 are respectively the second receiving differential pair of pins USB3_SSRX2+, USB3_SSRX2−, and are corresponding to the pins 17, 18 of the connection interface 102 or the pins 2, 3 of the connection interface 104. The pins 11, 13 are respectively the second transmission differential pair of pins USB3_SSTX2+, USB3_SSTX2−, and are corresponding to the pins 14-15 of the connection interface 102 or the pins 5, 6 of the connection interface 104. Furthermore, the pins 15, 16 are the ground pins. Therefore, when a motherboard operate with the USB 3.0, a USB 3.0 cable designed according to the front panel header definition of the connection interface 200 can be utilized for connecting the pins 1-20 of the connection interface 200 of the motherboard and a corresponding USB 3.0 transmission port. On the other hand, when the motherboard co-operates with the chip set and the transmission port of the USB 2.0 specifications, an existed USB 2.0 cable can be directly utilized for connecting the lower part of the connection interface 200 (i.e. pins 1-10), to achieve the USB 2.0 transmission function between the motherboard and the transmission port; thus, there is no need to re-establish a cable having 10 pins of the new specification. Comparatively, since the pins corresponding to the USB 2.0 and the USB 3.0 of the connection interfaces 102 and 104 respectively established by Intel and AMD are arranged dependently and staggered, a cable of the new specification is needed for co-operating with the existed transmission port or the chip set.

Therefore, the goal of the front panel header definition of the connection interface 200 is separating the set of the pins of the USB 2.0 and the set of the pins of the USB 3.0 to two independent blocks. Thus, the two sets of pins can be separately or jointly used according to different applications. In other words, the motherboard designed according to the front panel header definition of the connection interface 200 does not need to establish the cable of the new specification while co-operating with different chip sets, and those skilled in the art can use the connection interface 200 for different applications according to different requirements.

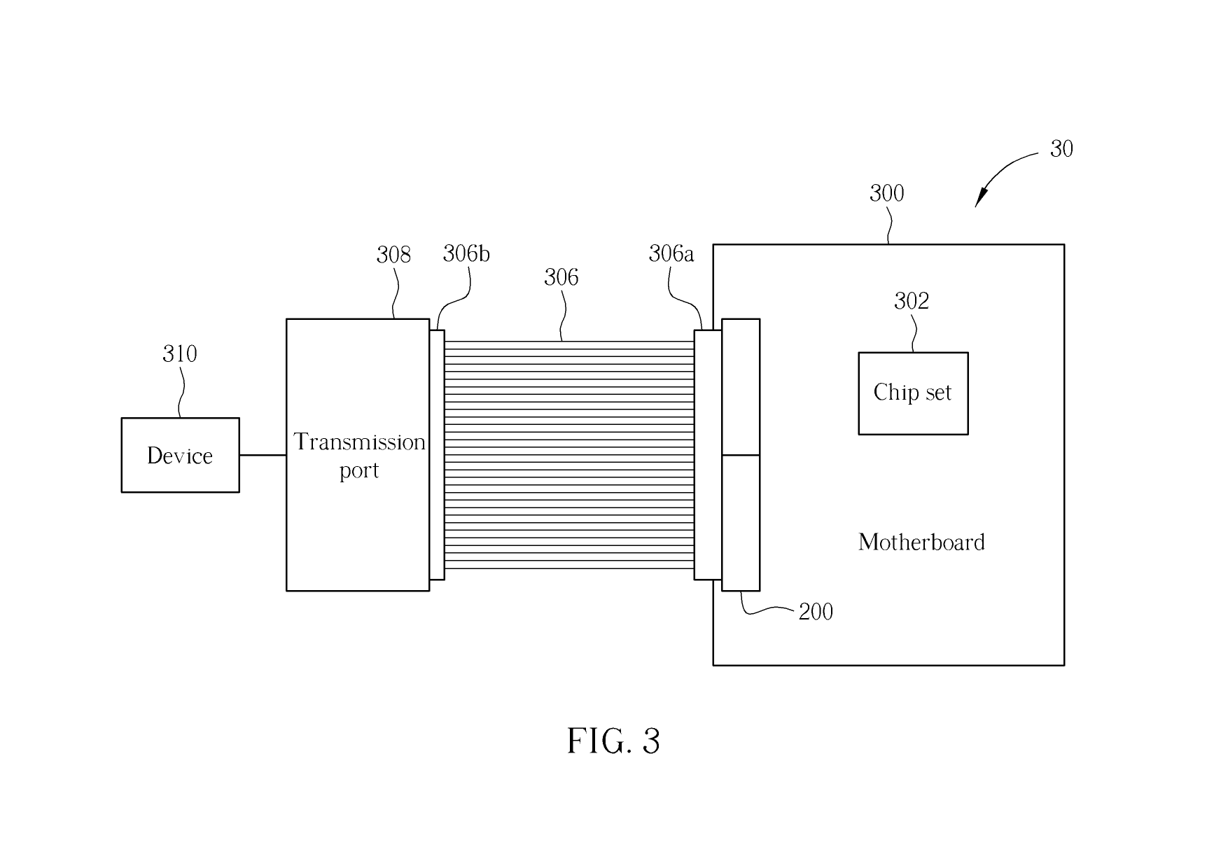

For example, please refer to FIG. 3, which is a schematic diagram of a data transmission system 30 using the connection interface 200 according to an embodiment of the invention. The data transmission system 30 comprises a motherboard 300, a cable 306, a USB transmission port 308 and a device 310, and is utilized for performing high speed data transmissions of the USB 3.0 specifications between the motherboard 300 and the device 310. The motherboard 300 comprises the connection interface 200 and a chip set 302 supporting the USB 3.0 specifications. The connection interface 200 is utilized for coupling the cable 306 to the transmission port 308. The chip set 302 is utilized for controlling the data transmissions between the motherboard 300 and the transmission port 308. The transmission port 308 and the cable 306 are designed according to the front panel header definition of the connection interface 200 of the invention. In detail, the cable 306 comprises a first connector 306a and a second connector 306b. The first connector 306a comprises 20 pins and can be coupled to the connection interface 200 of the motherboard 300. The second connector 306b also comprises 20 pins for coupling to the transmission port 308. Therefore, when the device 310 connects to the motherboard 300 through the transmission port 308, the chip set 302 can control the motherboard 300 and the device 310 to perform the high speed data transmissions of the USB 3.0 specifications.

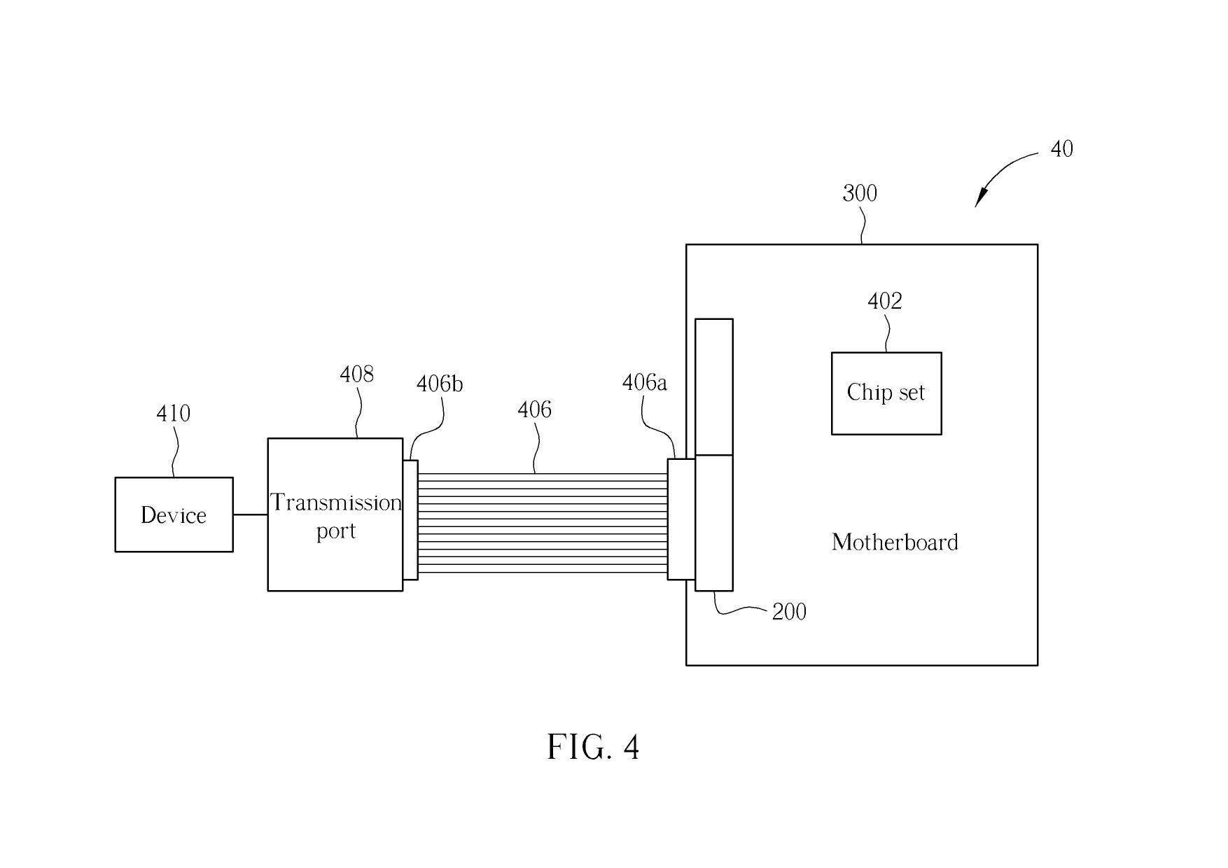

In another embodiment, the motherboard 300 can also co-operate with a chip set not supporting the USB 3.0 specifications. For example, please refer to the FIG. 4, which is a schematic diagram of a data transmission system 40. The data transmission system 40 is a co-operation of the motherboard 300 shown in FIG. 3 and a chip set 402 of the USB 2.0 specifications. The data transmission system 40 comprises the motherboard 300 shown in FIG. 3, a cable 406, a USB transmission port 408 and a device 410. The data transmission system 40 is utilized for performing data transmissions of the USB 2.0 specifications between the motherboard 300 and the device 410. The cable 406 is an existed USB 2.0 cable and comprises a first connector 406a and a second connector 406b. The first connector 406a only comprises 10 pins and can be coupled to the lower part of the connection interface 200 of the motherboard 300 (i.e. pins 1-10). As shown in FIG. 4, the second connector 406b also comprises 10 pins for being coupled to the transmission port 408. Therefore, when the device 410 connects to the motherboard 300 through the transmission port 408, the chip set 402 can control the motherboard 300 and the device 410 to perform the data transmission of the USB 2.0 specifications.

Note that, the spirit of the invention is establishing an innovative front panel header definition of the USB 3.0 specifications on a circuit board. As a result, the circuit board can use a transmission port of the front panel definition of the existed specifications when the circuit board co-operates with the chip set only supporting the USB 2.0 and use an exited USB 2.0 cable when assembling a system. The circuit board uses a transmission port designed according to the front panel header definition of the USB 3.0 specifications when the circuit board co-operates with a chip set supporting the USB 3.0 and uses a newly established USB 3.0 cable when assembling a system. According to different requirements, those skilled in the art can observe appropriate modifications and alternations. For example, in the connection interface 200, as long as the block of the pins of the USB 2.0 can be coupled to the connector of the existed USB 2.0 cable, the method of arranging the pins of the USB 2.0 and the pins of the USB 3.0 is not limited herein. In addition, the pins of the USB 3.0 can also be arranged in different methods, which is not limited herein.

To sum up, according to the conventional front panel header definition of the USB 3.0, when a circuit board co-operates with a chip set or a transmission port not supporting the USB 3.0, a cable of a new specification is needed to be established. In comparison, when a circuit board using the connection interface 200 of the invention co-operates with the chip set or the transmission port not supporting the USB 3.0, the circuit board can uses an exited USB 2.0 cable to achieve the transmission function of the USB 2.0, and does not need to re-establish a cable of the new specification. Therefore, the material cost and the manufacturing cost of the circuit board can be effectively reduced and the possibility of erroneously assembling also can be lowered.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A connection interface, comprising:
a first set of pins, comprising a plurality of pins corresponding to Universal Serial Bus (USB) 3.0 specifications; and
a second set of pins, comprising a plurality of pins corresponding to USB 2.0 specifications;
wherein the first set of pins and the second set of pins are arranged side-by-side with each other, and the second set of pins are arranged according to a front panel header definition of the USB 2.0 specifications.

2. The connection interface of claim 1, wherein the connection interface is utilized in a circuit board, for connecting the circuit board to a USB port via a cable.

3. The connection interface of claim 2, wherein the circuit board comprises a chip set, for controlling data transmissions between the circuit board and the USB port.

4. The connection interface of claim 3, wherein the cable supports the USB 2.0 specifications, when the chip set does not support transmissions of the USB 3.0 specifications.

5. The connection interface of claim 3, wherein the cable is coupled to the second set of pins, to connect the circuit board to the USB port, when the chip set does not support transmissions of the USB 3.0 specifications.

6. The connection interface of claim 3, wherein the cable supports the USB 3.0 specifications, when the chip set supports transmissions of the USB 3.0 specifications.

7. The connection interface of claim 3, wherein the cable is coupled to both the first set of pins and the second set of pins, to connect the circuit board to the USB port, when the chip set supports transmissions of the USB 3.0 specifications.

8. The connection interface of claim 1, wherein the connection interface is utilized in a USB port, for connecting a device corresponding to the USB port to a circuit board via a cable.

9. The connection interface of claim. 1, wherein the first set of pins comprises a plurality of differential transmission pair pins, power pins and ground pins conforming to the USB 3.0 specifications, and the second set of pins comprises a plurality of transmission pair pins, power pins and ground pins conforming to the USB 2.0 specifications.

10. The connection interface of claim 1, wherein the circuit board is a motherboard of a computer.

11. A cable, for connecting a circuit board and a Universal Serial Bus (USB) port to transmit data between the circuit board and the USB port, the cable comprising:
a first connector, for connecting to the circuit board, comprising:
a first set of pins, comprising a plurality of pins corresponding to USB 3.0 specifications; and
a second set of pins, comprising a plurality of pins corresponding to USB 2.0 specifications; and
a second connector for connecting to the USB port, comprising:
a third set of pins, comprising a plurality of pins corresponding to the USB 3.0 specifications, respectively coupled to the first set of pins of the first connector; and
a fourth set of pins, comprising a plurality of pins corresponding to the USB 2.0 specifications, respectively coupled to the second set of pins of the first connector;
wherein the first set of pins and the second set of pins are arranged side-by-side with each other, the third set of pins and the fourth set of pins are arranged side-by-side with each other, and the second set of pins and the fourth set of pins are arranged according to a front panel header definition of the USB 2.0 specifications.

12. The cable of claim 11, wherein the circuit board comprises a chip set for controlling data transmissions between the circuit board and the USB port.

13. The cable of claim 12, wherein the chip set supports transmissions of the USB 3.0 specifications.

14. The cable of claim 11, wherein the first set of pins and the third set of pins comprise a plurality of differential transmission pair pins, power pins and ground pins conforming to the USB 3.0 specifications, and the second set of pins and the fourth set of pins comprise a plurality of transmission pair pins, power pins and ground pins conforming to the USB 2.0 specifications.

15. The cable of the claim 11, wherein the circuit board is a motherboard of a computer.
